(19) United States
(12) Patent Application Publication
(10) Pub. No.: US 2011/0267370 A1
(43) Pub. Date: Nov. 3, 2011

(54) DRAWING LAYER CONTROL DEVICE

(75) Inventor: Shoji Tanaka, Tokyo (JP)

(73) Assignee: Mitsubishi Electric Corporation, Tokyo (JP)

(21) Appl. No.: 13/143,307

(22) PCT Filed: Jan. 6, 2009
(86) PCT No.: PCT/JP2009/000010

§ 371 Date: Jul. 5, 2011

(51) Int. Cl. G06T 11/00; G09G 5/377

(52) U.S. Cl. 345/634; 345/441

(57) ABSTRACT

A drawing layer control device includes a drawing frequency monitoring unit 104 for monitoring drawing update frequency of each window. When drawing update frequencies of windows allocated to the same layer differ, a drawing layer managing unit 105 reallocates windows with nearly the same drawing update frequency to the same layer.

### TECHNICAL FIELD

The present invention relates to a drawing layer control device having a plurality of windows corresponding to applications on each layer to display them.

### BACKGROUND ART

As for information processing systems having a display unit, those are known which show display contents of a plurality of applications using a window system. In the information processing systems having a window system installed, there are those that have a plurality of video memories as drawing layers, and display results drawn on the plurality of drawing layers by combining them when showing on a display such as a liquid crystal display or CRT. The window system installed in such a system with a plurality of drawing layers needs to decide a drawing layer in advance in which a memory area for drawing is to be reserved when generating the windows, and the decision is not changed thereafter in general (see Patent Document 1, for example).

Patent Document 1: Japanese Patent Laid-Open No. 2007-102751.

Accordingly, when a window with a high drawing update frequency and a window with a low drawing update frequency are mixed in the same drawing layer, the window with the low drawing update frequency must be redrawn every time the window with the high drawing update frequency is redrawn, offering a problem of decreasing the drawing efficiency.

In addition, to carryout synchronization control of windows allocated to different drawing layers when executing drawing synchronization processing between the windows, the system needs to wait for completion of drawing of the drawing layers to which the windows to be synchronized are allocated, and then to update the drawing simultaneously, offering a problem of complicating the processing.

The present invention is implemented to solve the foregoing problems. Therefore it is an object of the present invention to provide a drawing layer control device capable of improving the drawing efficiency.

### DISCLOSURE OF THE INVENTION

A drawing layer control device in accordance with the present invention is configured in such a manner as to monitor drawing update frequencies of the individual windows, and to reallocate, when the drawing update frequencies of the windows allocated to the same layer differ, the windows with nearly the same drawing update frequencies to the same layer. This makes it possible to improve the drawing efficiency of each drawing layer.

### BRIEF DESCRIPTION OF THE DRAWINGS

FIG. 1 is a block diagram showing a configuration of a drawing layer control device of an embodiment 1 in accordance with the present invention;

FIG. 2 is a diagram showing relationships between windows and drawing layers of the drawing layer control device of the embodiment 1 in accordance with the present invention;

FIG. 3 is a diagram showing relationships between drawing layers and addresses in a physical memory of the drawing layer control device of the embodiment 1 in accordance with the present invention;

FIG. 4 is a diagram showing a data structure for storing drawing update frequency of the individual windows of the drawing layer control device of the embodiment 1 in accordance with the present invention;

FIG. 5 is a diagram showing allocation change operation of the drawing layers of the drawing layer control device of the embodiment 1 in accordance with the present invention;

FIG. 6 is a flowchart showing layer allocation operation of the windows of the drawing layer control device of the embodiment 1 in accordance with the present invention;

FIG. 7 is a flowchart showing monitoring operation of drawing and drawing frequency of the windows of the drawing layer control device of the embodiment 1 in accordance with the present invention;

FIG. 8 is a flowchart showing layer allocation operation of the windows based on the drawing frequency of the drawing layer control device of the embodiment 1 in accordance with the present invention;

FIG. 9 is a block diagram showing a configuration of the drawing layer control device of an embodiment 2 in accordance with the present invention;

FIG. 10 is a flowchart showing window drawing and mask setting processing of the drawing layer control device of the embodiment 2 in accordance with the present invention;

FIG. 11 is a flowchart showing drawing layer allocation operation of the drawing layer control device of the embodiment 2 in accordance with the present invention;

FIG. 12 is a diagram showing relationships between a window and a mask of the drawing layer control device of the embodiment 2 in accordance with the present invention;

FIG. 13 is a diagram showing relationships between a drawing command and a mask setting of the drawing layer control device of the embodiment 2 in accordance with the present invention;

FIG. 14 is a block diagram showing a configuration of the drawing layer control device of an embodiment 3 in accordance with the present invention;

FIG. 15 is a diagram showing grouping of windows of the drawing layer control device of the embodiment 3 in accordance with the present invention; and

FIG. 16 is a flowchart showing drawing layer allocation operation of the drawing layer control device of the embodiment 3 in accordance with the present invention.

### EMBODIMENTS FOR CARRYING OUT THE INVENTION

The best mode for carrying out the invention will now be described with reference to the accompanying drawings to explain the present invention in more detail.

### Embodiment 1

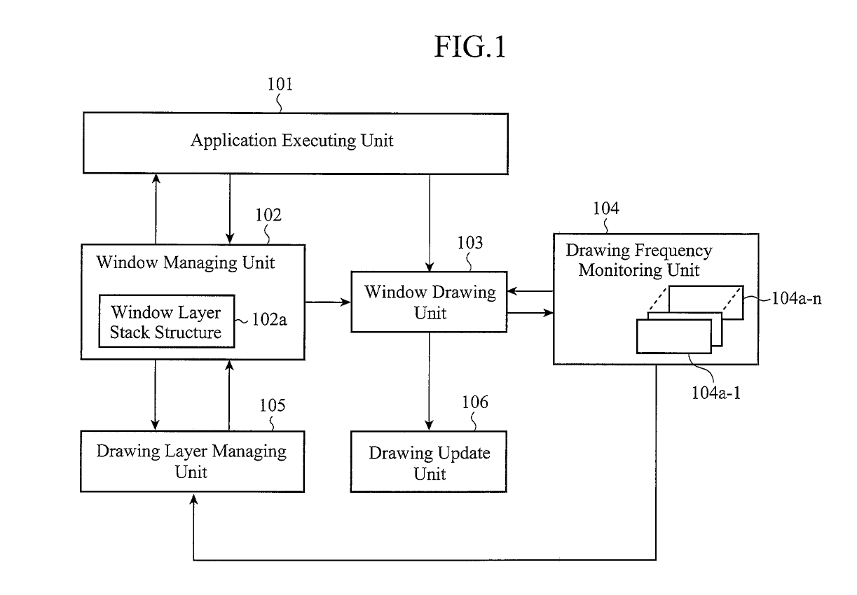

FIG. 1 is a block diagram showing a configuration of the drawing layer control device of an embodiment 1 in accordance with the present invention.

The drawing layer control device shown FIG. 1 comprises an application executing unit 101, a window managing unit 102, a window drawing unit 103, a drawing frequency monitoring unit 104, a drawing layer managing unit 105, and a drawing update unit 106.

The application executing unit 101 is a functional unit for executing various applications. The window managing unit 102 is a functional unit for managing windows corresponding to the individual applications executed by the application executing unit 101, and has a window layer stack structure 102a for managing the windows. As for the window layer stack structure 102a, it will be described later. The window drawing unit 103 is a functional unit for drawing the individual windows managed by the window managing unit 102 on a drawing layer allocated to a video memory. The drawing frequency monitoring unit 104 is a functional unit for monitoring the drawing frequency of the individual windows drawn by the window drawing unit 103, and has drawing update frequency monitoring tables 104a-1-104a-n for the respective drawing layers. The drawing layer managing unit 105 is a functional unit for allocating, when the drawing update frequency of the windows allocated to the same layer differs, the windows with nearly the same update frequency to the same layer. The drawing update unit 106 is a functional unit for updating a drawing layer.

Incidentally, the drawing layer control device is implemented by a computer, and the units from the application executing unit 101 to the drawing update unit 106 are composed of software corresponding to their functions and hardware such as a CPU and memory for executing them, or of dedicated hardware.

Next, the operation of the drawing layer control device with the foregoing configuration will be described.

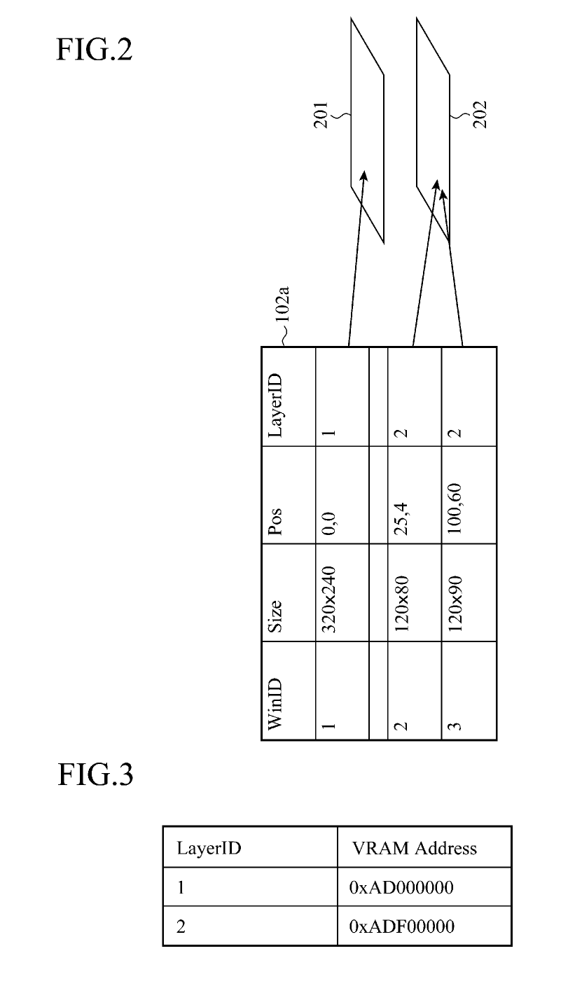

FIG. 2 is a diagram showing relationships between the windows generated by the application executing unit 101 and drawing layers (video memories) to which the windows are allocated.

FIG. 3 is a diagram showing relationships between the drawing layers and addresses of a physical memory.

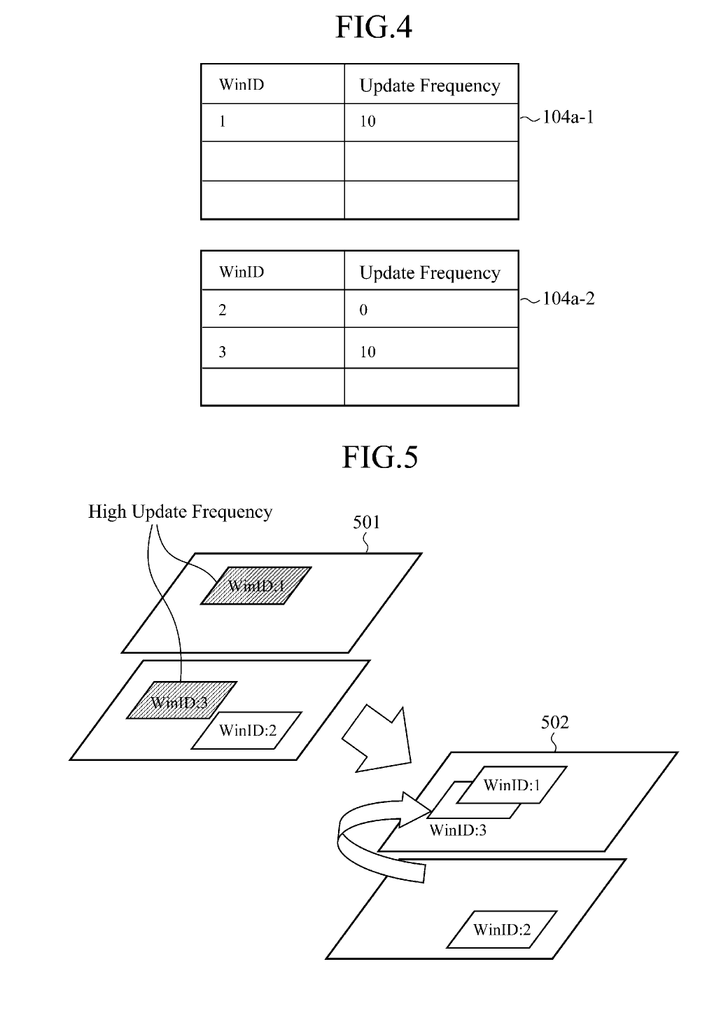

FIG. 4 is a diagram showing a data structure for storing drawing update frequencies of the individual windows.

FIG. 5 is a diagram showing allocation change operation of the drawing layers.

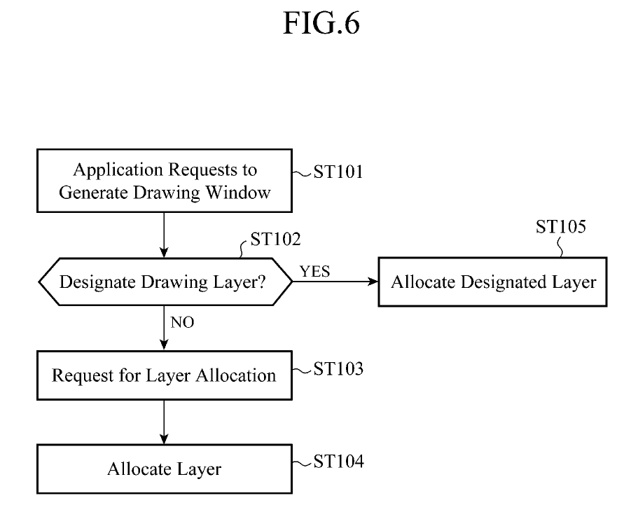

FIG. 6 is a flowchart showing layer allocation operation of the windows.

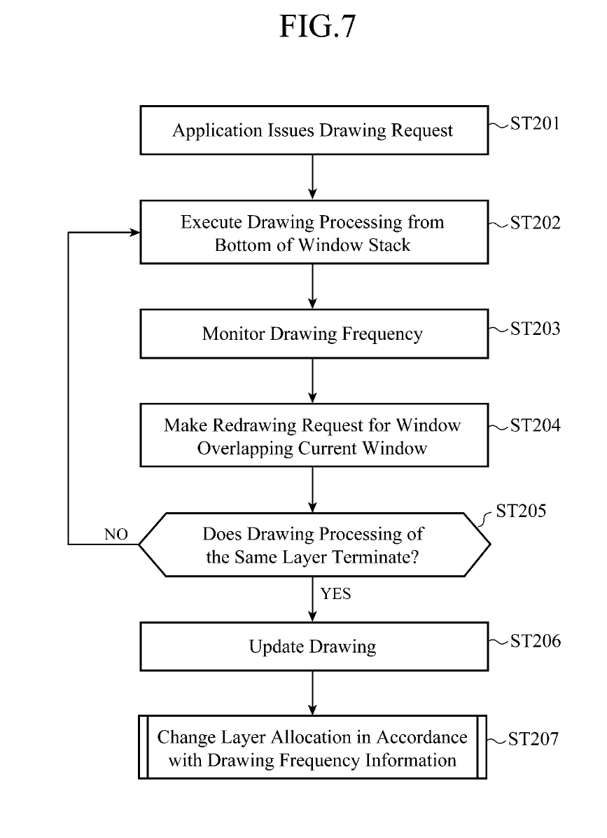

FIG. 7 is a flowchart showing monitoring operation of the window drawing and drawing frequency.

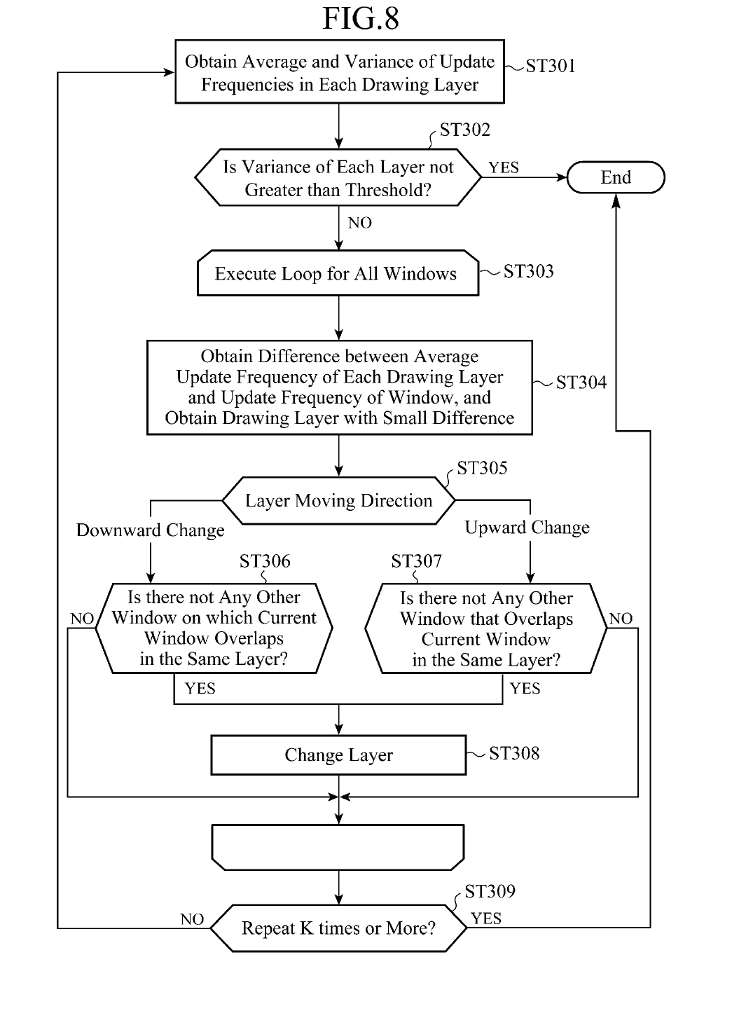

FIG. 8 is a flowchart showing the layer allocation operation of the windows based on the drawing frequency.

As shown in the flowchart of FIG. 6, when the application executing unit 101 makes a drawing window generation request to the window managing unit 102 (step ST101), the window managing unit 102 makes a decision as to whether the window generation request from the application executing unit 101 includes drawing layer designation or not (step ST102), and allocates, if it includes the designation, the drawing layer designated (step ST105). Here, the drawing layers are managed by the video memory addresses corresponding to the IDs as shown in FIG. 3.

Next, the window managing unit 102 records the information about the windows it generates in the window layer stack structure 102a. Here, the window layer stack structure 102a shows relationships between a window identification ID (WinID), size (Size), position (Pos) and layer ID (LayerID) indicating which layer the layer belongs to as shown in FIG. 2. In the example shown in FIG. 2, the window with the identification ID=1 is allocated to the drawing layer 1 (201), and the windows with the identification ID=2 and 3 are allocated to the drawing layer 2 (202).

At the foregoing step ST102, if the allocation designation is not present, the window managing unit 102 makes a layer allocation request to the drawing layer managing unit 105 (step ST103) to allocate the drawing layer of the window it generates to an upper layer, for example (step ST104).

For the window allocated in this way, the application executing unit 101 makes a drawing request where appropriate.

In the flowchart of FIG. 7, it is assumed that the window drawing unit 103 waits for the drawing request from the application executing unit 101 for a fixed time period, for an interval of the vertical synchronizing signal, for example. When the application executing unit 101 issues a drawing request (step ST201), the window drawing unit 103 processes the drawing request beginning from the lowest rank window referring to the window layer stack structure 102a to process drawing requests received within a fixed time period (step ST202). Here, the drawing frequency monitoring unit 104 monitors the drawing requests to the windows (step ST203), and records the information in the drawing update frequency monitoring table 104a-1 of the drawing layer 1 and in the drawing update frequency monitoring table 104a-2 of the drawing layer 2 as shown in FIG. 4. Here, it records the number of times of updates in the fixed time period, in one second, for example.

In addition, when there is a window that covers (overlaps) the window currently being drawn and that does not make a drawing request, the window managing unit 102 issues a redrawing request to the window drawing unit 103 (step ST204). This is because when the under window is updated by redrawing, the drawn content in the overlapping window on the window area is also altered, and hence the overlapping window must also be redrawn. Then, when all the drawing processing in the same layer has been completed at step ST205, the drawing update unit 106 transfer to a display not shown, or switches between a display surface and a drawing surface when the drawing layer is double buffered (step ST206).

Next, the drawing layer managing unit 105 makes a decision whether to alter the drawing layer in accordance with the drawing update frequency monitoring tables 104a-1 and 104a-2 for the individual drawing layers (step ST207).

In the drawing layer update decision by the drawing layer managing unit 105, it obtains the average and variance of the update frequencies of the windows in each drawing layer as shown in the flowchart of FIG. 8 (step ST301). Then, it makes a decision as to whether the variance of the update frequencies of the windows is not greater than a threshold or not (step ST302). If it is not greater than the threshold, that is, if the update frequencies of the windows allocated to each layer are steady for each layer, the processing is terminated immediately. On the other hand, if the variance exceeds the threshold at step ST302, the drawing layer managing unit 105 executes the following processing on all the windows (step ST303-step ST308).

First, the drawing layer managing unit 105 calculates the difference between the average update frequency of the windows in each drawing layer and the update frequency of the target window, and selects the drawing layer with the minimum difference (step ST304). It is the processing for collecting windows with the same update frequency.

When the drawing layer is obtained, the drawing layer managing unit 105 decides toward which drawing layer the target window moves when the target window is allocated to the drawing layer (step ST305). More specifically, when the window allocated to an upper layer moves to a lower layer, the direction becomes downward, and when the window allocated to a lower layer is allocated to an upper layer, the direction becomes upward.

At step ST305, if the layer moving direction is downward, the drawing layer managing unit 105 checks whether there is a window with which the target window overlaps in the same layer or not (step ST306). This is performed to check whether the order of the overlap between the windows is reversed or not when the window is moved downward. At step ST306, if there is no overlapping window, the layer is changed (step ST308). On the other hand, if there is an overlapping window at step ST306, the layer change for the window is disabled and no operation is executed.

Likewise, if the layer moving direction is upward at step ST305, the drawing layer managing unit 105 makes a decision as to whether there is a window overlapping the target window in the same layer (step ST307). If there is no overlapping window, the layer is changed (step ST308), and if there is an overlapping window, no operation is executed.

The above processing is repeated K times (K is an arbitrary integer) to optimize the drawing layer and then terminated. After that, the drawing update is performed in the optimized drawing layer.

For example, as shown in FIG. 4 and FIG. 5, when the drawing update frequency of a window 1 (WinID=1) and that of a window 3 (WinID=3) are high, and when the window 1 and window 3 are located in different drawing layers, although the drawing update of a window 2 (WinID=2) is unnecessary in itself, it has to be subjected to the drawing update because of the influence of the window 3.

Thus, changing the drawing layers from the state 501 to state 502 of FIG. 5 in accordance with the update frequency makes it possible not to perform the drawing update of the window 2, thereby being able to prevent unnecessary redrawing processing and to improve the drawing efficiency of the total system.

As described above, according to the drawing layer control device of the embodiment 1, it comprises the window managing unit for managing the windows corresponding to the applications; the window drawing unit for drawing the individual windows managed by the window managing unit on the drawing layers; the drawing frequency monitoring unit for monitoring the drawing update frequency of each window drawn by the window drawing unit; and the drawing layer managing unit for reallocating, when the windows allocated to the same layer have different drawing update frequencies, the windows having nearly the same drawing update frequencies to the same layer. Accordingly, it can improve the drawing efficiency for the individual drawing layers.

In addition, according to the drawing layer control device of the embodiment 1, the drawing layer managing unit is configured in such a manner as to obtain the variance of the drawing update frequencies of the windows in any drawing layer, and to change the allocation of a drawing layer with the variance not less than the fixed value. Accordingly, as for the layer in which the update frequencies of the windows are steady, it can be removed from the target of the allocation change. This makes it possible to obviate unnecessary processing and to increase the drawing efficiency.

### Embodiment 2

Although the embodiment 1 imposes a restriction on the drawing layer movement (whether windows overlap or not), the restriction can be lifted by setting a mask on the window. An example of this will be described below as an embodiment 2.

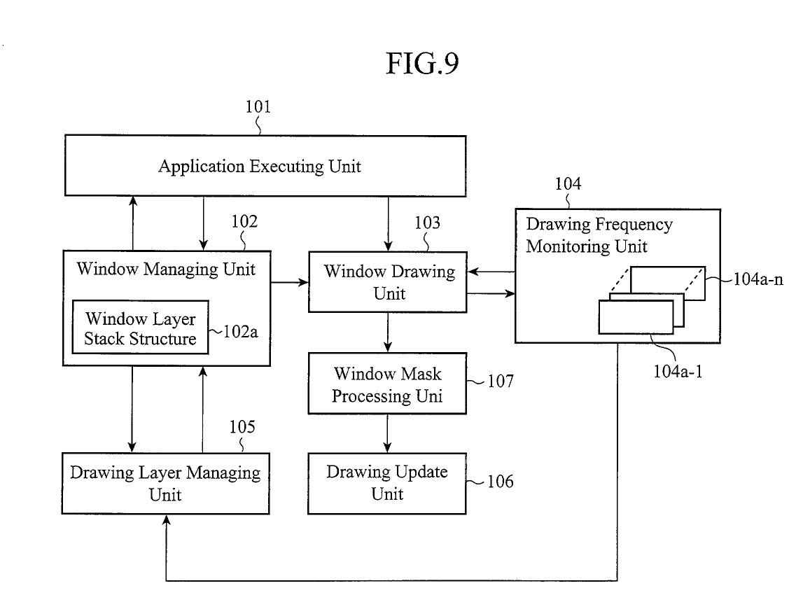

FIG. 9 is a block diagram showing a configuration of the drawing layer control device of the embodiment 2.

The configuration of the drawing layer control device of the embodiment 2 is the same as that of the embodiment 1 except that a window mask processing unit 107 is added to the configuration of the embodiment 1. The window mask processing unit 107 has a configuration of setting a mask on a non-display section which appears in a target window because another window overlaps it.

The operation of the drawing layer control device of the embodiment 2 will be described below.

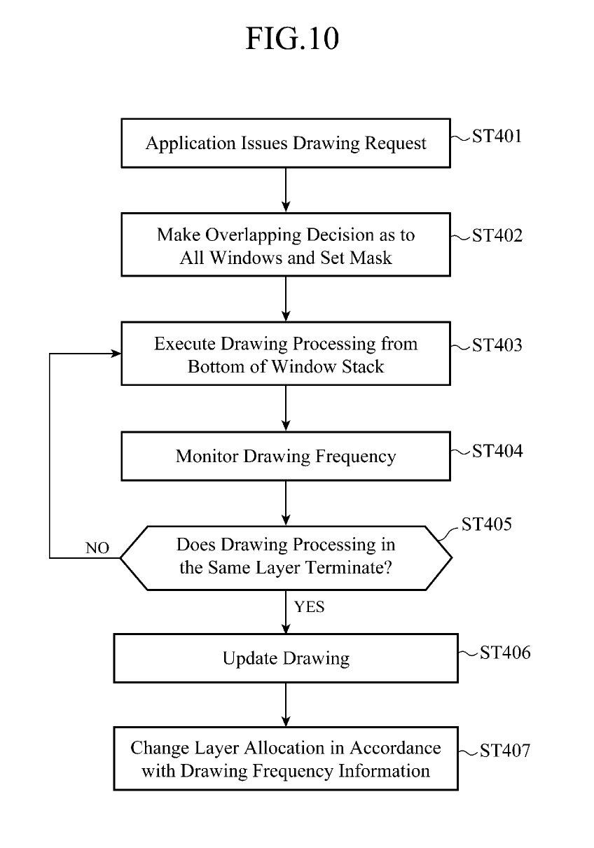

FIG. 10 is a flowchart showing window drawing and mask setting processing of the embodiment 2.

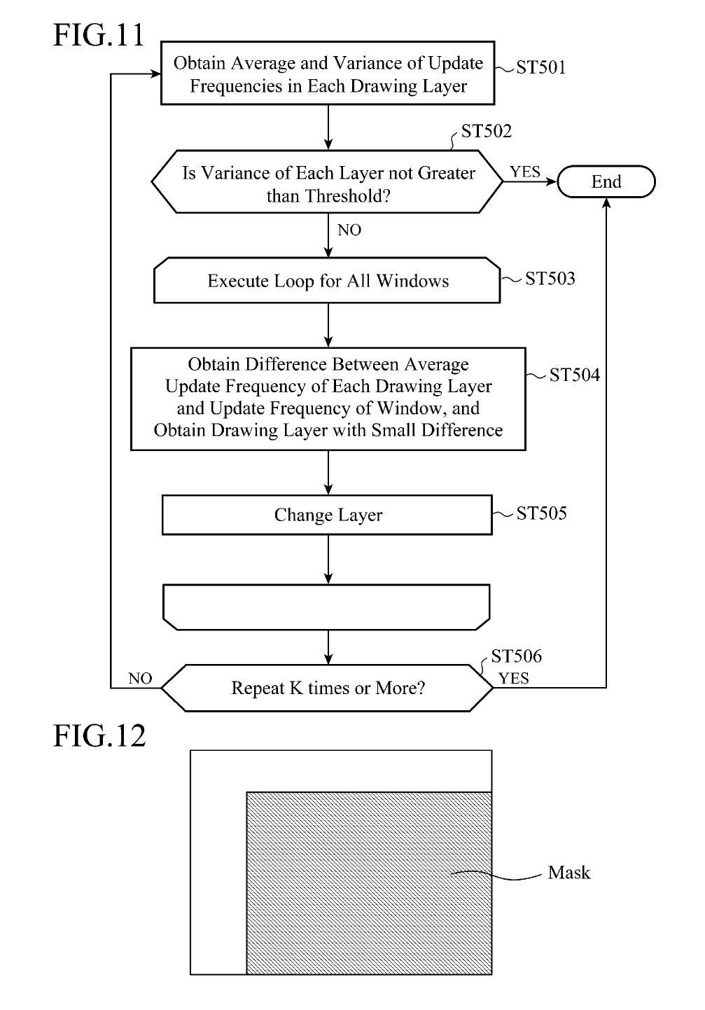

FIG. 11 is a flowchart showing drawing layer allocation operation of the embodiment 2.

First, the application executing unit 101 issues a drawing request (step ST401). As for the drawing request, the window drawing unit 103 receives it for a fixed period as in the embodiment 1.

Next, the window mask processing unit 107 makes an overlapping decision of all the windows, and adds masking processing of a non-display section of each window to a drawing command sequence of the window (step ST402).

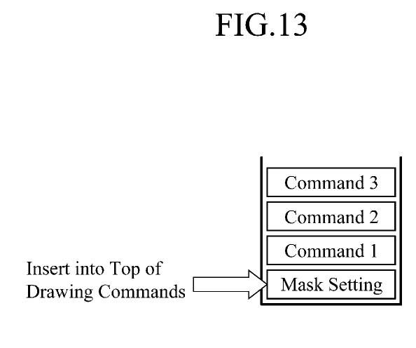

FIG. 12 is a diagram showing a non-display section of a window. The shaded area of FIG. 12 is a section where another window overlaps, and the area undergoes the masking processing. In addition, FIG. 13 is a diagram showing relationships between the drawing commands and the mask setting. As shown in FIG. 13, the mask setting is inserted into the top of the individual drawing commands (commands 1, 2, 3, . . . ). This means that the drawing of the window having a mask set is carried out in a state in which the mask is set without exception.

Returning to FIG. 10, the window drawing unit 103 executes the drawing processing in order beginning from the lowest window in accordance with the information in the window layer stack structure 102a (step ST403). In addition, the drawing frequency monitoring unit 104 monitors the drawing frequency (step ST404), and records the update information in the drawing update frequency monitoring tables 104a-1-104a-n.

When the drawing processing of the same layer has been completed (step ST405), the drawing update unit 106 executes drawing update (step ST406), and then performs the changing processing of the layer allocation in accordance with the drawing frequency (step ST407).

As for the update of the drawing layer by the drawing layer managing unit 105, it obtains the average and variance of the update frequencies of each drawing layer, first, as shown in the flowchart of FIG. 11 (step ST501). Then, it makes a decision as to whether the variance of each layer is not greater than a threshold (step ST502). If it is not greater than the threshold, that is, if the update frequencies of the windows allocated to each layer are steady for each layer, the processing is completed immediately. On the other hand, if the variance is greater than the threshold at step ST502, the following processing is executed for all the windows (step ST503-step ST505).

First, the drawing layer managing unit 105 obtains difference between the average update frequency of the windows in each drawing layer and the update frequency of the target window, selects the drawing layer with the minimum difference (step ST504), and changes the drawing layer (step ST505).

The drawing layer managing unit 105 repeats the processing, makes a decision as to whether it repeats K times (step ST506), and terminates when repeating K times. After that, it executes the drawing update using the optimized drawing layer.

As described above, according to the drawing layer control device of the embodiment 2, it is configured in such a manner as to include the window mask processing unit for setting a mask on the non-display section when the non-display section is present owing to an overlap of another window with the target window, and to draw using the mask if the mask is set on the window when drawing the window. Accordingly, the present embodiment 2 can change the drawing layer without restriction, thereby being able to display correctly even if the logical overlapping order of the windows does not agree with the physical overlapping order of the windows.

In addition, according to the drawing layer control device of the embodiment 2, it is configured in such a manner that the window mask processing unit inserts the mask setting into the top of the drawing commands of the target windows, and carries out the masking processing by executing the mask setting at the top when drawing the windows. Accordingly, it can apply the mask without fail when drawing the windows, thereby being able to execute the display correctly.

### Embodiment 3

The embodiment 3 is configured in such a manner as to group windows that have to be synchronized with each other.

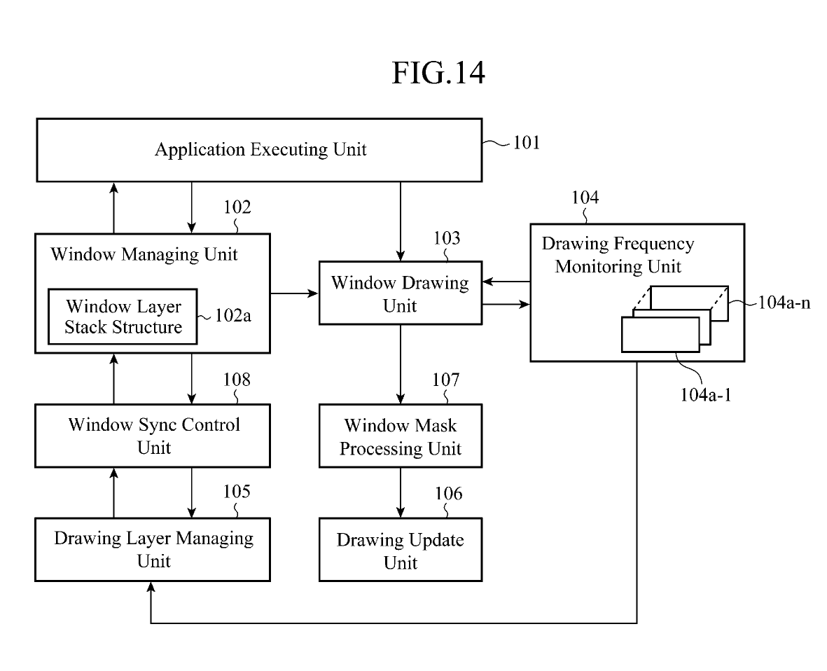

FIG. 14 is a block diagram showing a configuration of the drawing layer control device of the embodiment 3.

The drawing layer control device of the embodiment 3 has a window synchronization control unit 108 added to the drawing layer control device of the embodiment 2. The window synchronization control unit 108 is a functional unit for controlling synchronization drawing of the windows. More specifically, the window synchronization control unit 108 is configured in such a manner as to group the windows that require synchronization drawing between the windows. Then, the drawing layer managing unit 105 is configured in such a manner as to perform layer allocation of asynchronous windows in accordance with the drawing update frequencies of the windows. The remaining configuration is the same as that of the embodiment 2, and the description thereof is omitted here.

Next, the operation of the drawing layer control device of the embodiment 3 will be described.

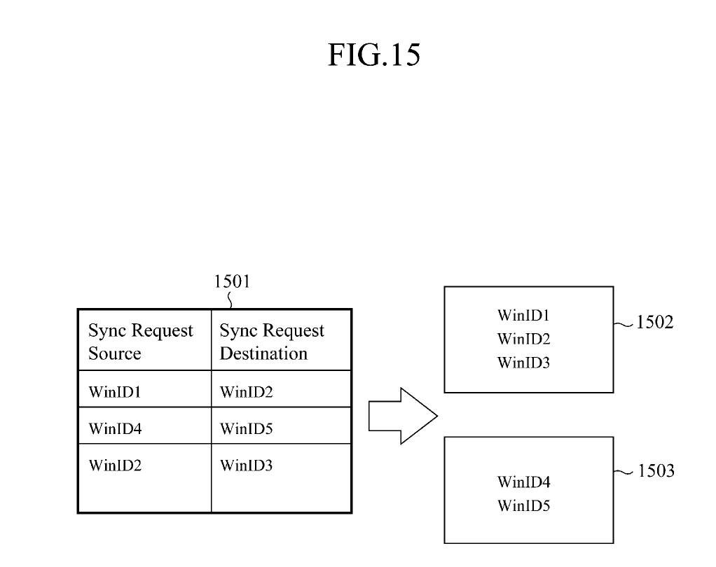

When carrying out drawing synchronization between the windows, the simplest method is to draw in the same drawing layer and to execute drawing update. Accordingly, the window synchronization control unit 108 receives from the application executing unit 101a drawing synchronization request such as a synchronization request list 1501 in FIG. 15, for example, divides the windows to be synchronized into groups such as a synchronized group 1 (1502) and synchronized group 2 (1503), and changes the allocation to the drawing layers. As for the asynchronous windows, the drawing layer is changed in accordance with the drawing update frequency in the same manner as the embodiment 1 and embodiment 2.

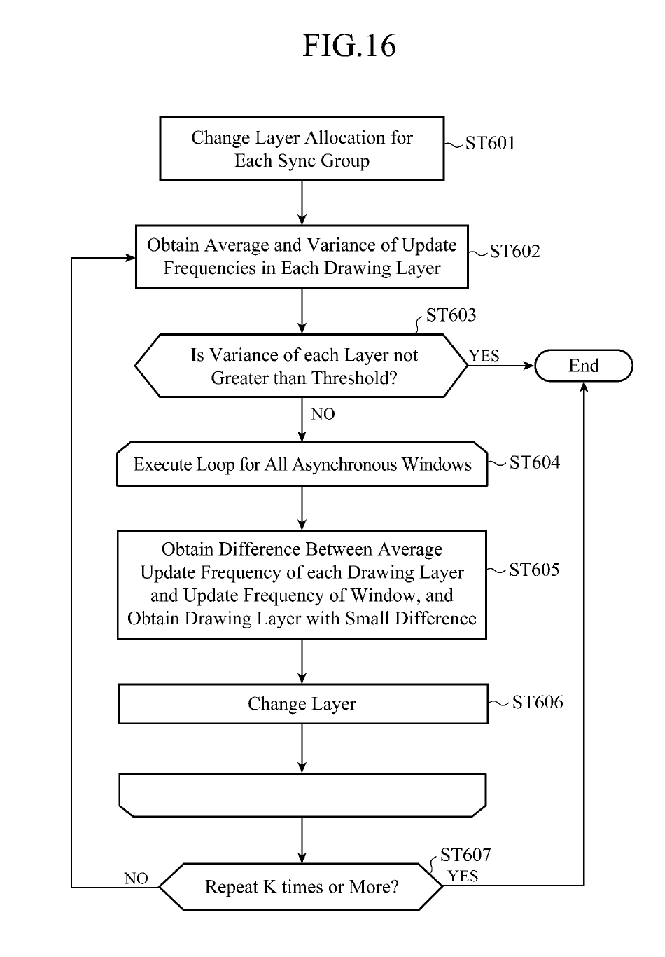

The update processing of the drawing layers in the embodiment 3 will be described with reference to FIG. 16.

First, the drawing layer managing unit 105 changes the allocation to the drawing layers in such a manner that the windows grouped by the window synchronization control unit 108 are assigned to the same drawing layer from group to group (step ST601). Next, the drawing layer managing unit 105 obtains the average and variance of the update frequencies for each drawing layer (step ST602). Then, it decides as to whether the variance of each layer is not greater than a threshold (step ST603). If the variance is not greater than the threshold, that is, if the update frequencies of the windows allocated to each layer are steady, the processing is terminated immediately. On the other hand, if the variance is greater than the threshold, the drawing layer managing unit 105 carries out the following processing on the asynchronous windows (step ST604-step ST606).

More specifically, the drawing layer managing unit 105 calculates difference between the average update frequency of each drawing layer and the update frequency of the target window, selects the drawing layer with the minimum difference (step ST605), and changes the drawing layer (step ST606).

The drawing layer managing unit 105 repeats the processing, terminates the layer allocation processing when it repeats K times (step ST607), and then executes the drawing update using the optimized drawing layer.

Incidentally, although the foregoing embodiment 3 is applied to the configuration of the embodiment 2, it can also be applied to the configuration of the embodiment 1.

As described above, according to the drawing layer control device of the embodiment 3, it is configured in such a manner that it comprises the window synchronization control unit for grouping the windows that require synchronization drawing between them, and for allocating the windows in the same group to the same drawing layer, and that the drawing layer managing unit reallocates, when the drawing update frequencies of the asynchronous windows differ, the asynchronous windows with nearly the same drawing update frequencies to the same layer. Accordingly, the present embodiment 3 can automatically allocate the windows to be subjected to the synchronization drawing to the same drawing layer, thereby being able to simplify the drawing processing and to further increase the drawing efficiency.

### INDUSTRIAL APPLICABILITY

As described above, a drawing layer control device in accordance with the present invention relates to a configuration for automatically changing the correspondence of the individual applications to the drawing layers by considering a drawing load and drawing synchronization. Accordingly, it is suitable for applications to information processing systems having a window system installed.

What is claimed is:

1. A drawing layer control device comprising:
a window managing unit for managing windows corresponding to applications;
a window drawing unit for drawing each window managed by the window managing unit on a drawing layer;
a drawing frequency monitoring unit for monitoring a drawing update frequency of each window drawn by the window drawing unit; and
a drawing layer managing unit for reallocating, when the drawing update frequencies of windows allocated to the same layer differ, windows with nearly the same drawing update frequency to the same layer.

2. The drawing layer control device according to claim 1, wherein
the drawing layer managing unit obtains variance of the drawing update frequencies of the individual windows in any drawing layer, and changes allocation of a drawing layer having the variance not less than a fixed value.

3. The drawing layer control device according to claim 1, further comprising:
a window mask processing unit for setting, when a non-display section occurs in a target window owing to overlapping of another window, a mask on the non-display section, wherein
the window drawing unit draws the window by applying the mask when the mask is set on the window.

4. The drawing layer control device according to claim 3, wherein
the window mask processing unit inserts the mask setting into the top of drawing commands of the target window; and
the window drawing unit executes masking processing by performing the mask setting at the top when drawing the window.

5. The drawing layer control device according to claim 1, further comprising:
a window synchronization control unit for grouping windows that require synchronization drawing between the windows, wherein
the drawing layer managing unit allocates the windows in the same group to the same drawing layer, and reallocates, when asynchronous windows have different drawing update frequencies, the asynchronous windows with nearly the same drawing update frequency to the same layer.
